(19) United States
(12) Patent Application Publication
(10) Pub. No.: US 2008/0144445 A1
(43) Pub. Date: Jun. 19, 2008

(54) Time display device and method thereof

(75) Inventor: Chia-Lung Yeh, Taipei City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: OA Furniture Co., Ltd., Taipei City (TW)

(21) Appl. No.: 11/638,083

(22) Filed: Dec. 13, 2006

(51) Int. Cl. G04C 19/00

(52) U.S. Cl. 368/82

(57) ABSTRACT

A time display device for conveying a current time of a day is provided. The time display device includes a first light emitting element for indicating a current hour by displaying an hour color selected from one of six colors, wherein the six colors respectively represent six hours in a quarter of a day; a second light emitting element indicating the current minute range by displaying one of six colors, wherein the six colors respectively represent one of six intervals of ten minutes in an hour; and a first circuit for controlling flashing at specific frequencies of each of the six colors assigned to the specific hours and minute intervals.

### FIELD OF THE INVENTION

The present invention relates to a time display device and method thereof, and more particularly to a time display device and a method for indicating the current time of day by displaying a specific color assigned thereto.

### BACKGROUND OF THE INVENTION

Generally, clocks and watches serve a time-keeping function, a time display function, and an ornamental/fashion function. Although time display methods have been developed over centuries, only two time display methods are commonly used in modern clocks and watches, namely: (1) the conventional analog clock approach, which provides a minute hand and an hour hand set against a clock face having 12 display units; and (2) the numerical digital display approach, which uses a liquid crystal display to create a numerical figure representing the hour to the left of a colon, and a numerical figure representing the minute to the right of the colon, as in the case of 9:53.

In U.S. Pat. No. 4,007,583, twelve indicator elements are arranged about the circumference of a timepiece to show different time units by different kinds of optical outputs such as steady and blinking illumination. This method is merely an application of the conventional analog clock with the incorporation of steady and blinking illumination.

The prior art time display devices require people's focused concentration, even for a few seconds, to determine the current time of day.

In view of the above, various types of alternative time display devices have been proposed to satisfy the diverse requirements of individuals in different situations. Until now, most commercial time display devices have conveyed the time of day either through the traditional analog clock approach or through the numerical digital approach. Accordingly, it is desirable to provide a novel time display device that offers an alternative means of conveying the current time of day.

In order to overcome the drawbacks in the prior art, a time display device that conveys the current time of day by displaying a specific color assigned thereto is provided. The particular design of the present invention not only solves the problems described above, but also may be easily implemented.

### SUMMARY OF THE INVENTION

It is therefore a primary object of the invention to provide a time display device for displaying the current time of day. The time display comprises a first light emitting element, a second light emitting element and a first circuit. The first light emitting element indicates the current hour by displaying an hour color selected from a first set of six colors, wherein the six colors in the first set respectively represent six specific hours in a quarter of a day. The second light emitting element indicates a current minute interval by displaying a minute interval color selected from a second set of six colors, wherein the six colors in the second set respectively represent six specific ten minute intervals in an hour. The first circuit controls timing for flashing of both the hour and minute interval color at predetermined frequencies.

Preferably, the quarter of the day is selected from the group consisting of 1 to 6 o'clock, 7 to 12 o'clock, 13 to 18 o'clock and 19 to 24 o'clock.

Preferably, the six specific ten minute intervals 1st to 10th minutes, 11th to 20th minutes, 21st to 30th minutes, 31st to 40th minutes, 41st to 50th minutes and 51st to 60th minutes.

Preferably, the six colors are eye-distinguishable from one another.

Preferably, the hour and the minute colors each flash at ten second intervals.

In one preferred embodiment, the hour color flashes just prior to the minute color.

In another preferred embodiment, the hour and minute colors flash simultaneously.

Preferably, the time display device further comprises three additional first light emitting elements to form an indicator for indicating the current quarter of the day by the number of the four light emitting elements that have been lighted.

Preferably, the time display device further comprises nine additional second light emitting elements to form a minute indicator for indicating a current minute in the ten minute interval by the number of the ten second light emitting elements that have been lighted.

Preferably, the time display device further comprises a plurality of third light emitting elements forming a second indicator for indicating the current quarter of the day by the number of third light emitting elements that have been lighted. The device also preferably comprises a plurality of fourth light emitting elements forming a minute indicator for indicating a current minute in the specific minute interval by means of a number of the plurality of fourth light emitting elements that have been lighted.

Preferably, the time display device further comprises a second circuit for modifying the hour and minute.

In accordance with one aspect of the present invention, a time display panel as described above is provided.

In accordance with another aspect of the present invention, a method for conveying current time of a day is provided. The method comprises the steps of: (1) assigning a first one of a first plurality of colors to a specific hour at one of a plurality of intervals of hours in a day; (2) assigning a second one of a second plurality of colors to a specific minute interval at one of a plurality of intervals of minutes in an hour; (3) communicating the current hour by displaying one of the first plurality of colors; and (4) communicating the current minute interval by displaying one of the second plurality of colors.

The above aspects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 depicts a flowchart for a method for conveying the current time of day according to the present invention;

FIG. 2 depicts a method for conveying current time of day according to an exemplary preferred embodiment of the present invention;

FIG. 3 depicts a schematic diagram of a time display device according to a first preferred embodiment of the present invention;

FIG. 4 depicts a schematic diagram of a time display device according to a second preferred embodiment of the present invention;

FIG. 5 depicts a schematic diagram of a time display device according to a third preferred embodiment of the present invention;

FIG. 6 depicts a schematic diagram of a time display device according to a fourth preferred embodiment of the present invention;

FIG. 7 depicts a schematic diagram of a time display device according to a fifth preferred embodiment of the present invention;

FIG. 8 depicts a diagram of a display panel of the time display device according to the first preferred embodiment of the present invention;

FIG. 9A depicts a diagram of a display panel of the time display device according to the third embodiment of the present invention;

FIG. 9B depicts a diagram of a display panel of the time display device according to the third embodiment of the present invention;

FIG. 10A depicts a diagram of a display panel of a time display device according to the fourth and the fifth embodiments of the present invention;

FIG. 10B depicts a diagram of a display panel of a time display device according to the fourth and the fifth embodiments of the present invention;

FIG. 10C depicts a diagram of a display panel of a time display devices according to the fourth and the fifth embodiments of the present invention; and

FIG. 10D depicts a diagram of a display panel of a time display devices according to the fourth and the fifth embodiments of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

DEFINITIONS: as used herein, “time display device” signifies any device which displays the current time of day, including, but not limited to, video displays (e.g., LCD, LED, plasma, etc.), flat panels and other electronic video displays and any object where a color display can be embedded; wearable displays; wristwatches; key palettes; personal digital assistants (PDAs), personal information managers (PIMs), and other handheld computers; VCRs; car stereos; pagers; phones; wall, desk, grandfather, tower, alarm and water clocks; microwave ovens and other appliances; cable TV set-top boxes; and any other mechanical or electric device that includes a visible time display.

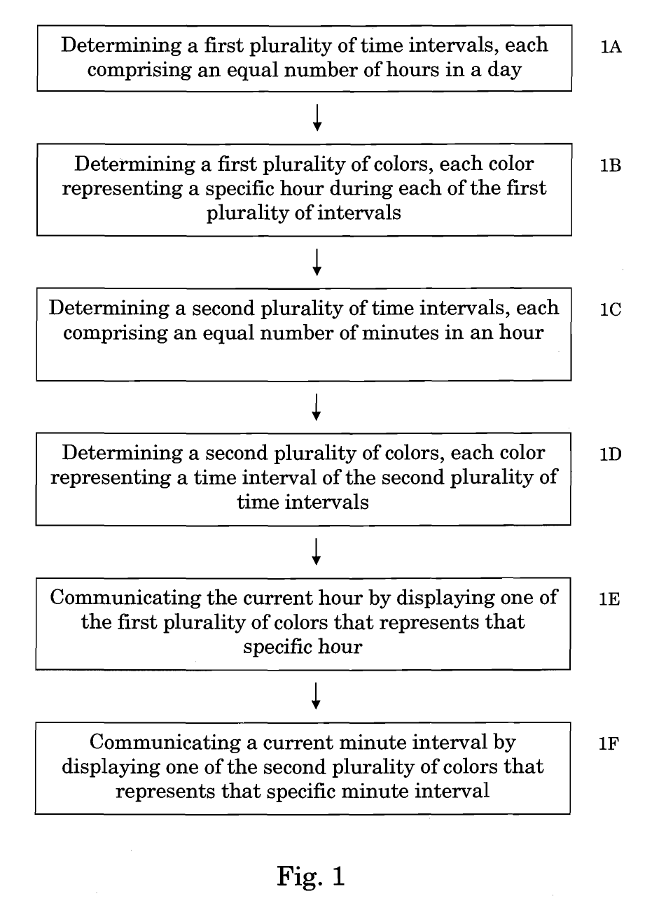

The present invention provides a method for conveying current time of day by displaying a representative color assigned to specific hour and minute intervals. Please refer to FIG. 1, which depicts a flowchart for a method of conveying the current time of day according to the present invention. First a first plurality of time intervals, each comprising an equal number of hours in a day is determined (step 1A). Second, a first plurality of colors, each color representing a specific hour during each of the first plurality of time intervals is determined (step 1B). Third, a second plurality of time intervals, each comprising an equal number of minutes in an hour is determined (step 1C). Fourth, a second plurality of colors, each color representing a time interval in the second plurality of time intervals is determined (step 1D). Fifth, the current hour is communicated by displaying one of the first plurality of colors assigned to that specific hour (step 1E). Finally, a current minute interval is communicated by displaying one of the second plurality of colors assigned to the specific minute interval (step 1F). The first and the second colors respectively display the current hour and the current minute interval at periodic, predetermined time periods.

The current time interval of the first plurality of time intervals is further indicated by the number of colors of the first plurality of colors that have been lighted. Correspondingly, the current minute of the second plurality of time intervals is indicated by the number of colors of the second plurality of colors that have been lighted.

As stated above, the determinations of how to divide the days and hours into intervals might depend on desired diverse necessities of people. A further description is introduced herein.

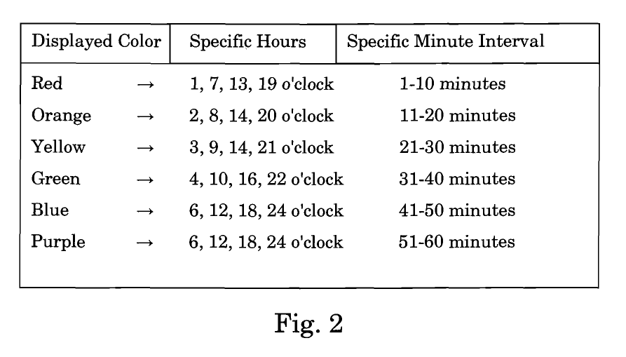

Please refer to FIG. 2, which depicts a time display method according to an exemplary preferred embodiment of the present invention. First of all, a day is divided into four intervals, and hence each of the four intervals has six hours. The divided four intervals of the day comprise sequentially 1 to 6 o'clock, 7 to 12 o'clock, 13 to 18 o'clock and 19 to 24 o'clock. Second, red, orange, yellow, green, blue and purple are respectively assigned to a first hour, a second hour, a third hour, a fourth hour, a fifth hour and a sixth hour in each of the four intervals of the day. That is, 1 o'clock, 7 o'clock, 13 o'clock and 19 o'clock are represented by displaying red; 2 o'clock, 8 o'clock, 14 o'clock and 20 o'clock are represented by displaying orange; 3 o'clock, 9 o'clock, 15 o'clock and 21 o'clock are represented by displaying yellow; 4 o'clock, 10 o'clock, 16 o'clock and 22 o'clock are represented by displaying green; 5 o'clock, 11 o'clock, 17 o'clock and 23 o'clock are represented by displaying blue; and 6 o'clock, 12 o'clock, 18 o'clock and 24 o'clock are represented by displaying purple.

Third, an hour is divided into six intervals, and hence each of the six intervals has ten minutes. The divided six intervals of the hour are sequentially 1 to 10 minutes, 11 to 20 minutes, 21 to 30 minutes, 31 to 40 minutes, 41 to 50 minutes and 51 to 60 minutes. Fourth, red, orange, yellow, green, blue and purple are respectively assigned to a first interval of 1 to 10 minutes, a second interval of 11 to 20 minutes, a third interval of 21 to 30 minutes, a fourth interval of 31 to 40 minutes, a fifth interval of 41 to 50 minutes and a sixth interval of 51 to 60 minutes in the hour in a similar way. That is, the first interval of 1 to 10 minutes is represented by displaying red; the second interval of 11 to 20 minutes is represented by displaying orange; the third interval of 21 to 30 minutes is represented by displaying yellow; the fourth interval of 31 to 40 minutes is represented by displaying blue; the fifth interval of 41 to 50 minutes is represented by displaying blue; and the sixth interval of 51 to 60 minutes is represented by displaying purple.

In addition, the mentioned colors assigned to the specific hour and minute intervals flash every ten seconds. Alternatively, the interval between flashing may be varied according to the user's preference. Furthermore, the color representing the hour may flash ahead of or simultaneously with that representing the current minute interval.

The plurality of colors representing the current minute intervals may be either the same as or different from the colors corresponding to the current hour.

In view of the foregoing, if the current time of day is 23:02, blue is displayed to indicate the hour and red is displayed to indicate the minute. Blue conveys that the current hour is the fifth hour in the interval of six hours of the day. Red conveys that the current minute is within the first interval of ten minutes in the hour.

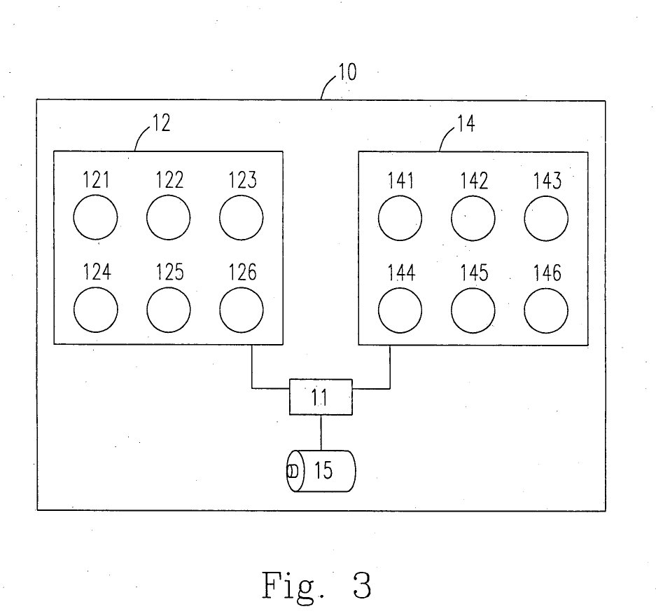

Please refer to FIG. 3, which depicts a time display device 10 according to a first preferred embodiment of the present invention. The time display device 10 comprises an hour indicating component 12, a minute interval indicating component 14, a timing control circuit 11 and a battery 15. The hour indicating component 12 comprises six light emitting elements, which are respectively a light emitting element 121 capable of displaying the red color assigned to the first hour in an interval of six hours, a light emitting element 122 capable of displaying the orange color assigned to the second hour in the interval of six hours, a light emitting element 123 capable of displaying the yellow color assigned to the third hour in the interval of six hours, a light emitting element 124 capable of displaying the green color assigned to the fourth hour in the interval of six hours, a light emitting element 125 capable of displaying the blue color assigned to the fifth hour in the interval of six hours, and a light emitting element 126 capable of displaying the purple color assigned to the sixth hour in the interval of six hours.

The minute interval indicating component 14 also comprises six light emitting elements, which are respectively a light emitting element 141 capable of displaying the red color assigned to the first interval of ten minutes in the hour, a light emitting element 142 capable of displaying the orange color assigned to the second interval of ten minutes in the hour, a light emitting element 143 capable of displaying the yellow color assigned to the third interval of ten minutes in the hour, a light emitting element 144 capable of displaying the green color assigned to the fourth interval of ten minutes in the hour, a light emitting element 145 capable of displaying the blue color assigned to the fifth interval of ten minutes in the hour, and a light emitting element 146 capable of displaying the purple color assigned to the sixth interval of ten minutes in the hour.

The light emitting element 121 is switched on to display the red color representing 1, 7, 13 and 19 o'clock among the divided four intervals in the day. Similarly, the light emitting element 141 is also switched on to display the red light representing the first interval of 1-10 minutes in the hour. Accordingly, the light emitting elements 122 and 142 are switched on to show the orange color representing 2, 8, 14 and 20 o'clock and the second interval of 11-20 minutes in the hour, respectively. The light emitting elements 123 and 143 are switched on to show the yellow color representing the respective 3, 9, 15 and 21 o'clock and the third interval of 21-30 minutes, respectively. The light emitting elements 124 and 144 are switched on to show the green color representing the respective 4, 10, 16 and 22 o'clock and the fourth interval of 31-40 minutes, respectively. The light emitting elements 125 and 126 are switched on to show the blue color representing the respective 5, 11, 17 and 23 o'clock and the fourth interval of 41-50 minutes, respectively. The light emitting elements 126 and 146 are switched on to show the green color representing the respective 6, 12, 18 and 24 o'clock and the sixth interval of 51-60 minutes, respectively.

Furthermore, the timing control circuit 11 is used for controlling the timing for flashing of the colors displayed by the mentioned light emitting elements. In addition, the color displayed by the light emitting elements of the hour indicating component 12 flashes ahead of or simultaneously with that displayed by the light emitting elements in the minute interval indicating component 14.

The battery 15 is used for supplying a starting voltage to switch on the mentioned light emitting elements. The number of batteries 25 necessary therefore depends on the number of the light emitting elements disposed in the time display device 10. Moreover, the light emitting elements in the time display device 10 are preferably light emitting diodes or organic light emitting diodes.

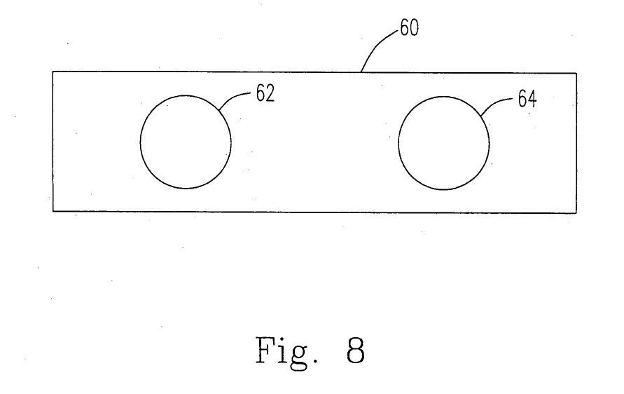

Please refer to FIG. 8 together with FIG. 3. FIG. 8 depicts a time display panel 60 of the time display device 10 according to the first preferred embodiment of the present invention. The time display panel comprises an hour indicating light 62 and a minute interval indicating light 64. The hour indicating light 62 indicates the current hour by displaying a color assigned to a specific hour corresponding thereto. The displayed color is illuminated by one of the six light emitting elements 121-126 disposed in the hour indicating component 12 of FIG. 3. The minute interval indicating light 64 indicates the current minute interval by displaying the color assigned to a specific minute interval corresponding thereto. This color is also illuminated by one of the six light emitting elements 141-146 disposed in the minute interval indicating component 14 of FIG. 3.

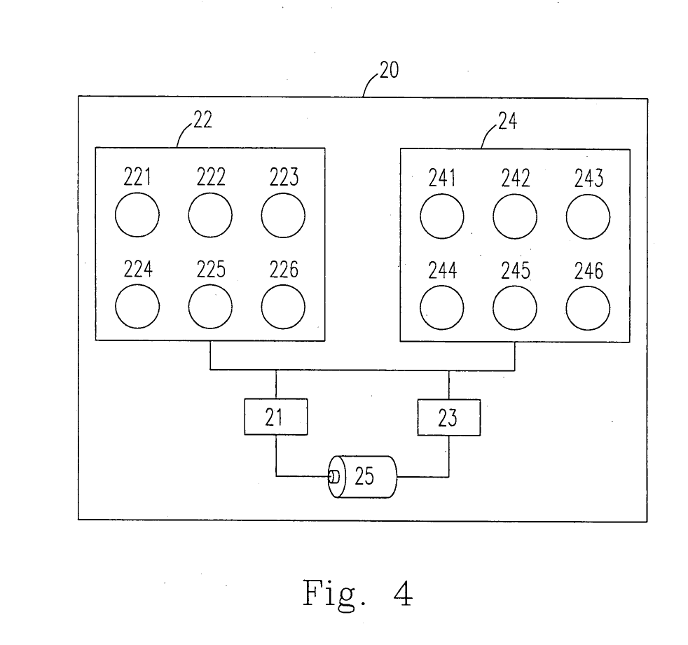

Please refer to FIG. 4, which depicts a time display device 20 according to a second preferred embodiment of the present invention. The time display device 20 further comprises a second circuit 23. The second circuit 23 is used to modify the colors respectively assigned to the specific hours in each interval of a day and to the specific minute intervals in the hour. Users can assign another color to replace the original one assigned to the specific hour and the specific minute intervals according to their preference, such as a red color for a lunch time, a blue color for a meeting hour, an orange color for a break time and so on.

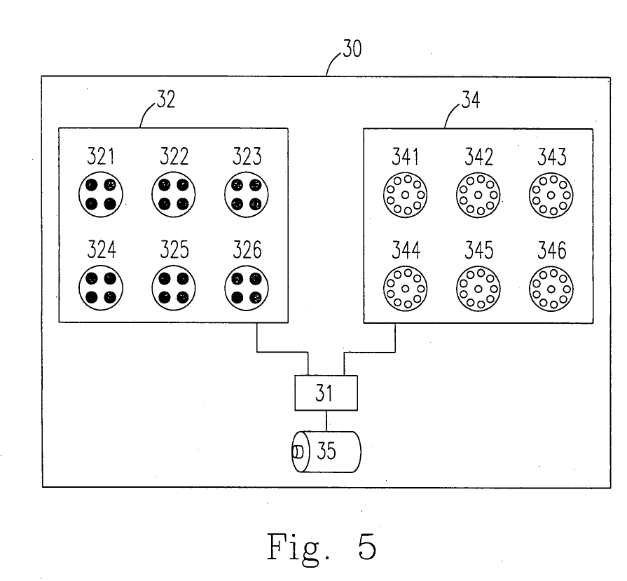

Please refer to FIG. 5, which depicts a time display device 30 according to a third preferred embodiment of the present invention. The time display device 30 comprises an hour indicating component 32, a minute interval indicating component 34, a timing control circuit 31 and a battery 35. The hour indicating component 32 comprises six hour sub-indicating components 321-326, wherein each of the six hour sub-indicating components 321-326 further comprises four light emitting elements. The minute interval indicating component 34 also comprises six minute interval sub-indicating components 341-346, wherein each of the six minute interval sub-indicating components 341-346 further comprises ten light emitting elements.

The four light emitting elements in the hour sub-indicating component 321 are capable of displaying red to indicate the first hour in the interval of six hours; similarly the four light emitting elements in the respective hour sub-indicating components 322, 323, 324, 325 and 326 are capable of displaying orange, yellow, green, blue and purple, respectively to indicate the specific hours represented thereby.

Furthermore, the ten light emitting elements in the minute interval sub-indicating component 341 are capable of displaying red to indicate the first interval of ten minutes in the hour; similarly the respective ten light emitting elements in the minute interval sub-indicating components 342, 343, 344, 345 and 346 are capable of displaying orange, yellow, green, blue and purple, respectively to indicate the specific minute intervals represented thereby.

In view of the above, the changes in the hour and minute intervals are conveyed by displaying the color assigned thereto. Furthermore, the four light emitting elements in each of the hour sub-indicating components 321-326 are utilized to indicate the current hour interval of a day. If the current hour is between 1-6 o'clock, one of the four light emitting elements in each of the six hour sub-indicating components 321-326 will be lighted. If the current hour is between 7-12 o'clock, two of the four light emitting elements in each of the hour sub-indicating components 321-326 will be lighted. If the current hour is between 13-18 o'clock, three of the four light emitting elements in each of the six hour sub-indicating components 321-326 will be lighted. Moreover, if the current hour is between 19-24 o'clock, all of the four light emitting elements in each of the six hour sub-indicating components 321-326 will be lighted. That is, if the current hour is 8 o'clock, the hour sub-indicating component 322 will be switched on to display orange and two of the four light emitting elements therein will be lighted.

In addition, the current minute of the ten minute interval is indicated by the number of the ten light emitting elements in each of the minute interval sub-indicating components 341-346 that have been lighted. If the current minute is 59, the minute interval sub-indicating component 346 will be switched on to display purple and nine of the ten light emitting elements therein will be lighted.

The timing control circuit 31 and the battery 35 are operated in a similar way to that described above.

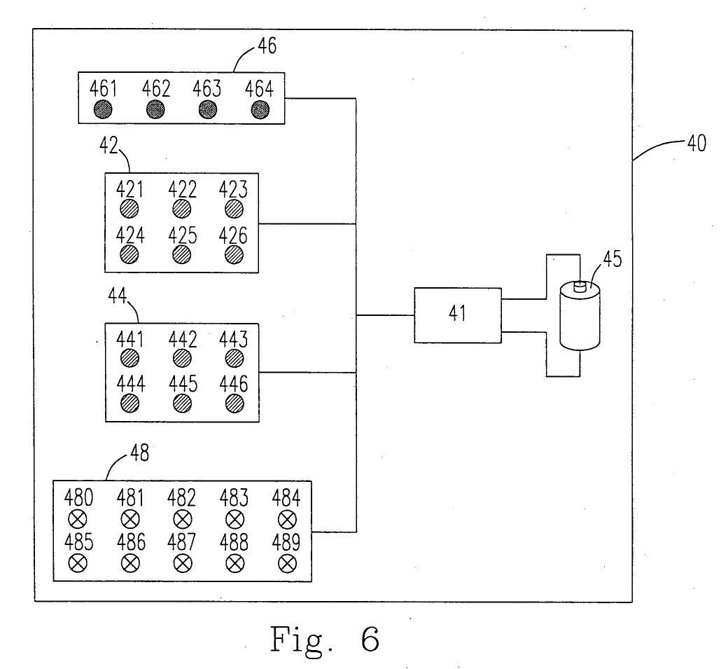

Please refer to FIG. 6, which depicts a time display device 40 according to a fourth embodiment of the present invention. The time display device 40 comprises an hour indicating component 42, a minute interval indicating component 44, an hour interval indicating component 46, a minute indicating component 48, a timing control circuit 41 and a battery 45. The respective functions of the hour indicating component 42 and the minute interval indicating component 44 are similar to those described with respect to FIGS. 3 and 4, where the hour indicating component 42 comprises six light emitting elements 421-426 and the minute interval indicating component 44 comprises six light emitting elements 441-446. The hour interval indicating component 46 further comprises four light emitting elements 461-464, and the hour interval of the day is conveyed by the number of the four light emitting elements 461-464 that have been lighted. Further, the minute indicating component 48 also comprises ten light emitting elements 480-489, and the current minute is conveyed by the number of the ten light emitting elements 480-489 that have been lighted.

The timing control circuit 41 and the battery 45 are operated in a similar way to that described above.

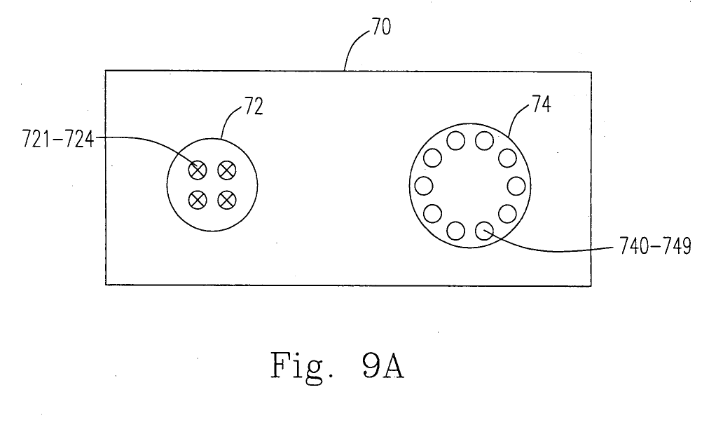

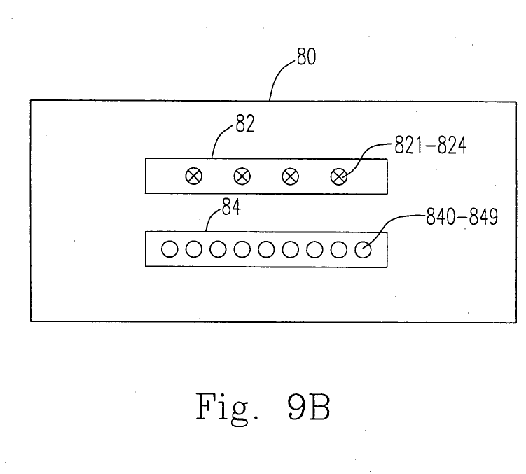

Please refer to FIGS. 9A and 9B together with FIG. 5. FIG. 9A and FIG. 9B respectively depict time display panels 70 and 80 of the time display device 30 according to the third preferred embodiment of the present invention. The time display panel 70 comprises an hour indicating light 72 and a minute interval indicating light 74. The time display panel 80 comprises an hour indicating light 82 and a minute interval indicating light 84. The hour indicating lights 72 and 82 each consist of four hour indicating sub-lights 721-724, 821-824. The minute interval indicating lights 74 and 84 each consist of ten minute interval indicating sub-lights 740-749, 840-849. If the current time is 10:18, two of the hour indicating sub-lights 721-724 and 821-824 in the respective hour indicating lights 72 and 82 will be shown in yellow, and eight of the minute interval indicating sub-lights 740-749 and 840-849 in the respective minute interval indicating lights 74 and 84 will be shown in orange.

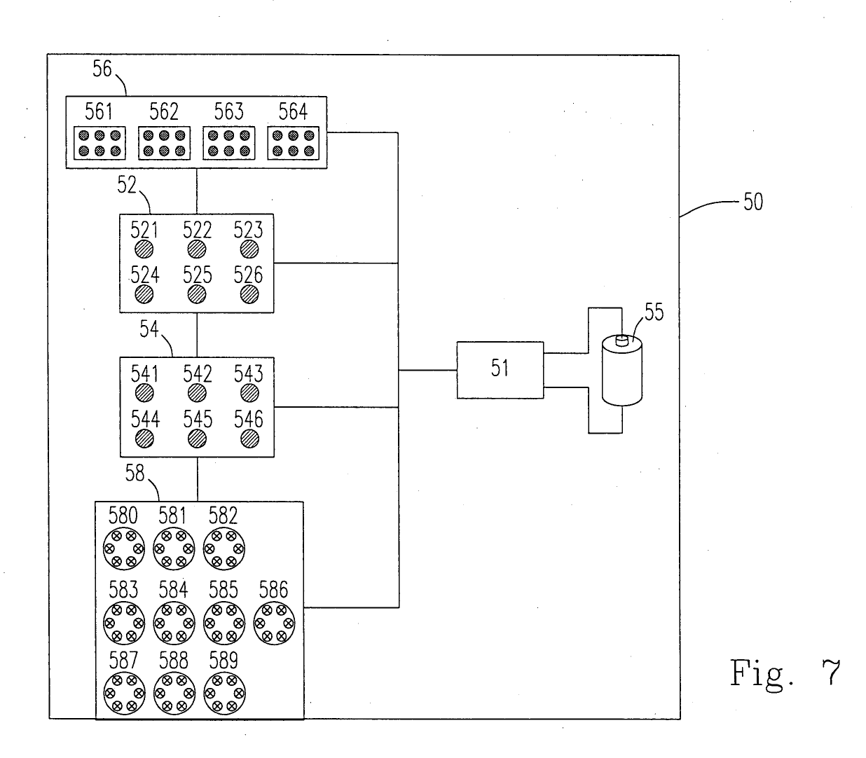

Please refer to FIG. 7, which depicts a time display device 50 according to a fifth preferred embodiment of the present invention. The time display device 50 comprises an hour indicating component 52, a minute interval indicating component 54, an hour interval indicator 56, a minute indicator 58, a timing control circuit 51 and a battery 55. The respective functions of the hour indicating component 52 and the minute interval indicating component 54 are also similar to those illustrated in FIGS. 3-5. The hour interval indicator 56 further comprises four hour interval sub-indicators 561-564, wherein each of the four hour interval sub-indicators 561-564 comprises six light emitting elements corresponding to those of the hour indicator 52. Therefore, the color displayed by the hour interval sub-indicators 561-564 is capable of varying with that displayed by the hour indicator 52. The minute indicator 58 comprises ten minute sub-indicators 580-589, where each of the minute sub-indicators 580-589 comprises six light emitting elements corresponding to those of the minute interval indicator 54. Accordingly, the color displayed by the minute sub-indicators 580-589 is capable of varying with that displayed by the minute interval indicator 54.

The timing control circuit 51 and the battery 55 are operated in a similar way to that described above.

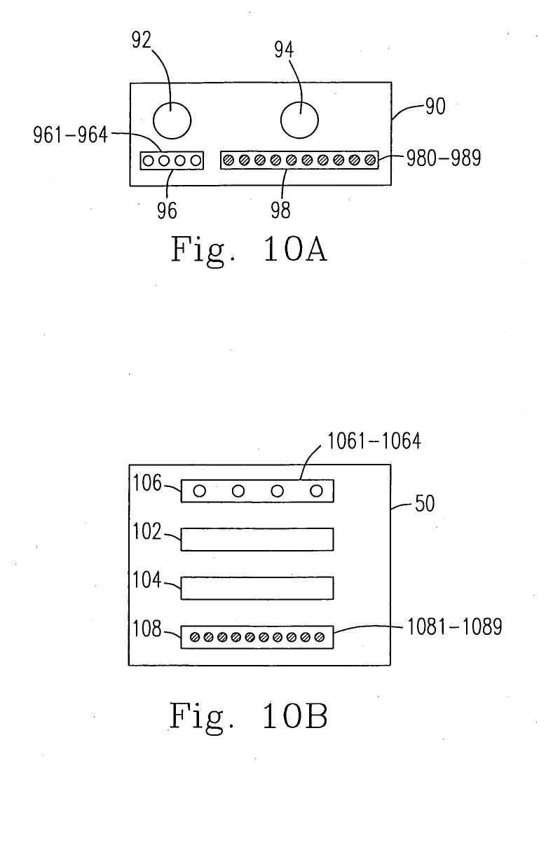

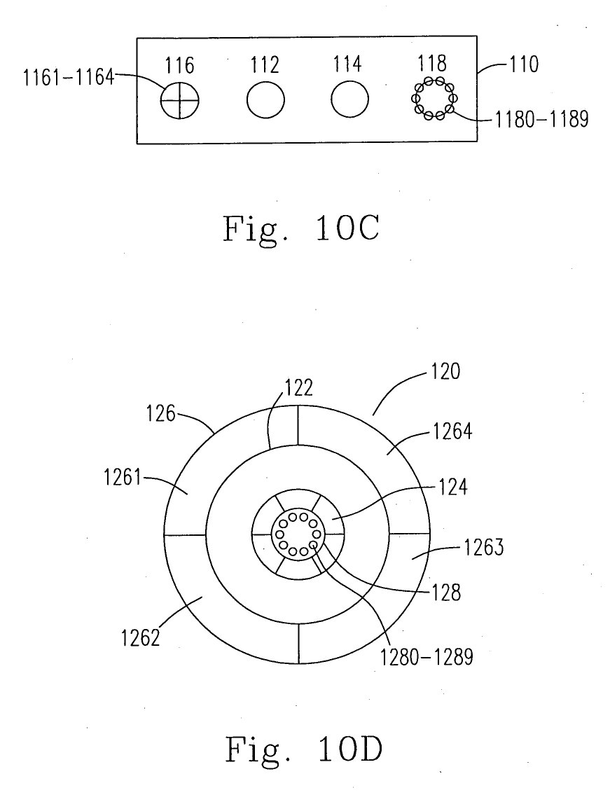

Please refer to FIGS. 10A-10D, which respectively depict time display panels 90, 100, 110 and 120 displayed by time display devices 40 and 50 according to preferred embodiments of the present invention. The time display panel 90 in FIG. 10A comprises an hour indicating light 92, a minute interval indicating light 94, an hour interval indicating segment 96 and a minute indicating segment 98. The time display panel 100 in FIG. 10B comprises an hour indicating light 102, a minute interval indicating light 104, an hour interval indicating segment 106 and a minute indicating segment 108. The time display panel 110 in FIG. 10C comprises an hour indicating light 112, a minute interval indicating light 114, an hour interval indicating segment 116 and a minute indicating segment 118. The time display panel 120 in FIG. 10D comprises an hour indicating light 122, a minute interval indicating light 124, an hour interval indicating segment 126 and a minute indicating segment 128. The respective hour indicating lights 92, 102, 112 and 122 and the respective minute interval indicating lights 94, 104, 114 and 124 display one of six colors to convey the current hour. The hour interval indicating segments 96, 106, 116 and 126 respectively consist of four hour interval indicating lights 961-964, 1061-1064, 1161-1164 and 1261-1264. The number of the respective four hour indicating lights 961-964, 1061-1064, 1161-1164 and 1261-1264 that have been lighted indicate the current hour interval of a day. The respective minute indicating segments 98, 108, 118 and 128 respectively consist of ten minute indicating lights 980-989, 1080-1089, 1180-1189 and 1280-1289. The number of the respective four hour indicating lights 980-989, 1080-1089, 1180-1189 and 1280-1289 that have been lighted indicate the current minute.

If the current time is 11:47, the hour indicating lights 92, 102, 112 and 122 are shown in green and the minute interval indicating lights 94, 104, 114 and 124 are shown in blue. In addition, two of the hour indicating lights 961-964, 1061-1064, 1161-1164 and 1261-1264 in the respective hour indicators 96, 106, 116 and 126 will be lighted in one color or the color which is the same as that displayed by the hour indicating lights 92, 102, 112 and 122. Furthermore, seven of the minute indicating lights 980-989, 1081-1089, 1180-1189 and 1280-1289 in the respective minute indicating segments 98, 108, 118 and 128 will be lighted in one color or the color which is the same as that displayed by the minute interval indicating lights 94, 104, 114 and 124.

By virtue of the foregoing, the colored display lights may be arranged in various ways and are not limited to the mentioned embodiments.

The time display device and the method thereof provided by the present invention not only applies the concept of color usage to time display but further applies it for ornamental purposes, a teaching auxiliary for children, or other specific uses.

In conclusion, the time display device and the method thereof provided by the present invention are very practical in certain situations, especially for activities held at night. Accordingly, the present invention can provide an alternative time display choice.

While the invention has been described in terms of what is presently considered to be the most practical and preferred embodiments, it is to be understood that the invention need not be limited to the disclosed embodiments. On the contrary, it is intended to cover various modifications and similar arrangements included within the spirit and scope of the appended claims which are to be accorded the broadest interpretation so as to encompass all such modifications and similar structures.

1. A time display device for conveying the current time of day, comprising:
a first light emitting element that indicates a current hour by displaying an hour color selected from a first set of six colors, wherein each of the six colors represents one of six specific hours of a six hour interval;
a second light emitting element that indicates a current minute range by displaying a minute color selected from a second set of six colors, wherein each of the six colors represents one of six specific ten minute intervals in an hour; and
a first circuit that controls a frequency of flashing of each of the light emitting elements.

2. The time display device of claim 1, wherein the six hour interval is selected from the group consisting of 1 to 6 o'clock, 7 to 12 o'clock, 13 to 18 o'clock and 19 to 24 o'clock.

3. The time display device of claim 1, wherein the of ten minutes intervals comprise 1 to 10 minutes, 11 to 20 minutes, 21 to 30 minutes, 31 to 40 minutes, 41 to 50 minutes and 51 to 60 minutes.

4. The time display device of claim 1, wherein each of the six colors are eye-distinguishable from each other.

5. time display device of claim 1, wherein the frequency is ten seconds.

6. The time display device of claim 1, wherein the the first light emitting element flashes before the second light emitting element flashes.

7. The time display device of claim 1, wherein the first and second light emitting elements flash simultaneously.

8. A time display device of claim 1, further comprising:
three additional first light emitting elements to form an indicator that indicates a current quarter of the day by the number of the four first light emitting elements that have been lighted.

9. The time display device of claim 1, further comprising:
nine additional second light emitting elements to form a minute indicator that indicates a current minute in the specific minute range by the number of the ten second light emitting elements that have been lighted.

10. The time display device of claim 1, further comprising:
a plurality of third light emitting elements forming an indicator that indicates a current quarter of the day by the number of light emitting elements of the plurality of third light emitting elements that have been lighted; and
a plurality of fourth light emitting elements forming a minute indicator that indicates a current minute in the specific minute range by the number of light emitting elements of the plurality of fourth light emitting elements that have been lighted.

11. The time display device of claim 1, further comprising:
a second circuit that modifies each of the hour and minute colors.

12. A display panel for displaying current time of day, comprising:
a first light having a color selected from one of six colors, that indicates a current hour in a hour interval;
a second light having a color selected from one of six colors that indicates a current ten minute interval;
wherein each of the first and the second lights flash at predetermined frequencies.

13. The display panel of claim 12, further comprising:
three additional first lights that indicate a current quarter of the day by the number of the four first lights that have been lighted; and
nine additional second lights that indicate a current minute in the ten minute interval by the number of the ten second lights that have been lighted.

14. The display panel of claim 12, further comprising:
four third lights that indicate a current quarter of the day by the number of the four third lights that have been lighted; and
ten fourth lights that indicate a current minute in the ten minute interval by the number of the ten fourth lights that have been lighted.

15. A method for conveying the current time of day, comprising the steps of:
determining a first plurality of time intervals, each comprising an equal number of hours in a day;
determining a first plurality of colors, each color representing a specific hour of each of the first plurality of time intervals;
determining a second plurality of time intervals, each comprising an equal number of minutes in an hours;
determining a second plurality of colors, each color representing a time interval of the second plurality of time intervals;
conveying a current hour by displaying a color belonging to the first plurality of colors that represents that hour; and
conveying a current minute interval by displaying a color belonging to second plurality of colors that represents that minute interval;
wherein each of the displayed colors flashes at a predetermined frequency.

16. The method of claim 15, wherein the first plurality of colors comprises six colors.

17. The method of claim 15, wherein the second plurality of colors comprises six colors.

18. The method of claim 15, wherein the third plurality of colors comprises four colors.

19. The method of claim 15, wherein the fourth plurality of colors comprises ten colors.
